(19) United States
(12) Patent Application Publication
(10) Pub. No.: US 2017/0046412 A1
(43) Pub. Date: Feb. 16, 2017

(54) Method for Querying and Updating Entries in a Database

(71) Applicant: Huawei Technologies Co., Ltd., Shenzhen (CN)

(72) Inventors: Eliezer Levy, Munich (DE); Donald Kossman, Zurich (CH); Lucas Braun, Zurich (CH); Thomas Etter, Zurich (CH); Georgios Gasparis, Zurich (CH); Daniel Widmer, Zurich (CH); Aharon Avitzur, Munich (DE); Martin Kaufmann, Zurich (CH); Antonios Iliopoulos, Munich (DE)

(21) Appl. No.: 15/282,037

(22) Filed: Sep. 30, 2016

Related U.S. Application Data
(63) Continuation of application No. PCT/EP2014/075745, filed on Nov. 27, 2014.

(30) Foreign Application Priority Data
Apr. 1, 2014 (EP) EP14163009.5

(51) Int. Cl. G06F 17/30

(52) U.S. Cl. CPC G06F 17/30569; G06F 17/30345; G06F 17/3033; G06F 17/30477; G06F 17/30598; G06F 17/30368

(57) ABSTRACT

The disclosure relates to a method for querying and updating entries in a database, the database comprising a main data structure for storing database entries and a delta data structure for storing new entries, the method comprising the following steps: receiving a plurality of database queries, aggregating a received plurality of database queries to obtain a batch of database queries, performing a shared scan of the main data structure with the batch of database queries, wherein the database entries in the main data structure are queried with respect to each database query in the batch of database queries, after the step of performing the shared scan, merging the main data structure with the delta data structure to update the main data structure with the received new entries.

### CROSS-REFERENCE TO RELATED APPLICATIONS

This application is a continuation of International Application No. PCT/EP2014/075745, filed on Nov. 27, 2014, which claims priority to European Patent Application No. EP14163009.5, filed on Apr. 1, 2014, both of which are hereby incorporated by reference in their entireties.

### BACKGROUND

There are a number of techniques and systems that have been developed to query database entries. Most importantly, there has been significant amount of work on main-memory database systems since the eighties. Prominent examples are MICROSOFT's HEKATON, ORACLE's TIMES TEN, and SAP's HANA products. Typically, these systems perform well either on point queries and point updates or on complex queries, but rarely on both. HEKATON and TIMES TEN, for instance, may not perform well on complex queries.

Recently, a number of techniques have been proposed in the research literature to address mixed workloads. One example is the HYPER system, which exploits the “copy on write” hardware primitive to efficiently separate update and query processing and achieve good isolation at the same time. Another approach is the CLOCKSCAN method, which is based on shared scans and which have been explored extensively in the context of complex query processing in data warehouses. To date, however, systems that are based on shared scans do not perform well on point queries and updates.

Another technique that is often used to process complex queries is vertical partitioning. This technique has been exploited in the design of so-called column stores such as MONETDB and C-STORE.

### SUMMARY

It is an object of the disclosure to provide an efficient concept for querying and updating a database.

This object is achieved by the features of the independent claims. Further embodiments are apparent from the dependent claims, the description and the figures.

According to a first aspect, the disclosure relates to a method for querying and updating entries in a database, the database comprising a main data structure for storing database entries and a delta data structure for storing and/or receiving new entries, the method comprising the following steps receiving a plurality of database queries, aggregating the received plurality of database queries to obtain a batch of database queries, performing a shared scan of the main data structure with the batch of database queries, wherein the database entries in the main data structure are queried with respect to each database query in the batch of database queries, and, after the step of performing the shared scan, merging the main data structure with the delta data structure to update the main data structure with the new entries.

In a first possible implementation form of the method according to the first aspect, the method comprises receiving a further plurality of database queries, wherein the following steps are performed after the step of merging the main data structure with the delta data structure to update the main data structure with the new entries: aggregating the received further plurality of database queries to obtain a further batch of database queries, performing a further shared scan of the main data structure with the further batch of database queries, wherein the database entries in the main data structure are queried with respect to each query in the further batch of database queries, after performing the further shared scan, merging the main data structure with the delta data structure to update the main data structure with new entries stored in the delta data structure or received by the delta data structure.

In a second possible implementation form of the method according to the first aspect, the steps of performing the shared scan and merging the main data structure with the delta data structure are performed at different instants of time.

In a third possible implementation form of the method according to the first aspect, the steps of performing the shared scan and merging the main data structure with the delta data structure are performed at predetermined instants of time.

In a fourth possible implementation form of the method according to the first aspect, the method comprises establishing queues for different classes of database queries, in particular for point queries or analytic queries.

In a fifth possible implementation form of the method according to the fourth possible implementation form, the method comprises scheduling the classes of database queries in the batch of database queries in dependence of a response time requirement for each class database queries.

In a sixth possible implementation form of the method according to the first aspect, the method comprises receiving a plurality of new entries, aggregating a received plurality of new entries to obtain a batch of new entries, and updating the delta data structure with the batch of new entries in an update step.

In a seventh possible implementation form of the method according to the first aspect, the shared scan or the merging of the main data structure with the delta data structure or updating the delta data structure with new entries are performed using indices or at least one hash table.

In an eighth possible implementation form of the method according to the first aspect, the method comprises receiving a database query, determining a class of the received database query, and depending on the determined class, including the database query into the batch of database queries, or directly querying the main data structure with the received database query upon the basis of a hash table.

In a ninth possible implementation form of the method according to the eighth possible implementation form, the method comprises, executing the batch of database queries and directly querying the main data structure in an interleaved manner or in a shared manner.

In a tenth possible implementation form of the method according to the first aspect, the method comprises performing a snapshot isolation of the batch of database queries.

In an eleventh possible implementation form of the method according to the first aspect, the method comprises receiving new entries for updating the delta data structure.

According to a second aspect, the disclosure relates to a computer program for executing the method of the first aspect or one of the embodiments of the first aspect when run on a computer.

According to a third aspect, the disclosure relates to a data processing system, comprising a database, the database comprising a main data structure for storing database entries and a delta data structure for storing and/or receiving new entries, a communication interface for receiving a plurality of database queries and for receiving new entries, and a processor, wherein the processor is configured to aggregate the received plurality of database queries to obtain a batch of database queries, to perform a shared scan of the main data structure with the batch of database queries, wherein the database entries in the main data structure are queried with respect to each database query in the batch of database queries, and, after the step of the shared scan, to merge the main data structure with the delta data structure to update the main data structure with the new entries.

The data processing system can perform the method. Further features of the data processing system can directly result from the functionality of the method.

In a first possible implementation form of the system according to the second aspect, the processor is configured to perform the shared scan and to merge the main data structure with the delta data structure at different instants of time or at predetermined instants of time.

In a second possible implementation form of the system according to the second aspect, the data processing system, in particular the processor, is programmably arranged to execute the computer program of the second aspect.

According to some embodiments, the system, in particular the processor, is configured to execute the method according to the first aspect or to any implementation form of the first aspect. The method steps are performed electronically and automatically.

### BRIEF DESCRIPTION OF THE DRAWINGS

The disclosure can be implemented in hardware and/or software. Further embodiments will be described with respect to the following figures, in which:

FIG. 1 shows a diagram of a method for querying and updating entries in a database according to an implementation form.

FIG. 2 shows a diagram of a system for querying and updating entries in a database according to an implementation form.

FIG. 3A shows a diagram of a system for querying and updating entries in a database according to an implementation form.

FIG. 3B shows a diagram of a system for querying and updating entries in a database according to an implementation form.

FIG. 4 shows a diagram of a system for querying and updating entries in a database according to an implementation form.

FIG. 5 shows a diagram of an update of a database according to an implementation form.

FIG. 6 shows a diagram of an update and a querying of a database according to an implementation form.

FIG. 7 shows a diagram of a system for querying and updating entries in a database according to an implementation form.

FIG. 8 shows a diagram of a hash table according to an implementation form.

FIG. 9 shows a diagram of an update and a querying of a database according to an implementation form.

FIG. 10 shows a diagram of a single instruction multiple data (SIMD) processing scheme according to an implementation form.

FIG. 11 shows a diagram of a system for querying and updating entries in a database according to an implementation form.

FIGS. 12A and 12B shows performance diagrams of a system for querying and updating entries in a database according to an implementation form.

FIGS. 13A and 13B shows performance diagrams of a system for querying and updating entries in a database according to an implementation form.

FIG. 14 shows performance diagrams of a system for querying and updating entries in a database according to an implementation form.

### DESCRIPTION OF EMBODIMENTS

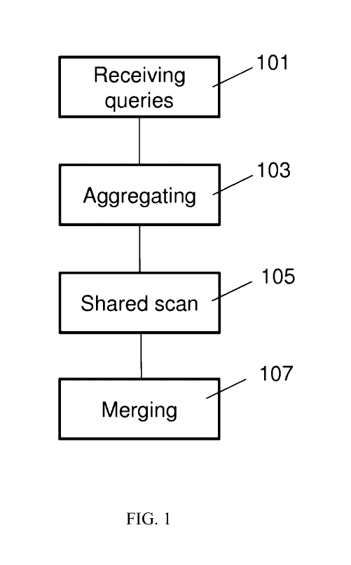

FIG. 1 shows a diagram of a method for querying and updating entries in a database, the database comprising a main data structure for storing database entries and a delta data structure for storing new entries, the method comprising the following steps: receiving 101 a plurality of database queries, aggregating 103 the received plurality of database queries to obtain a batch of database queries, performing 105 a shared scan of the main data structure with the batch of database queries, wherein the database entries in the main data structure are queried with respect to each database query in the batch of database queries, after the step of performing 105 the shared scan, merging 107 the main data structure with the delta data structure to update the main data structure with the received new entries.

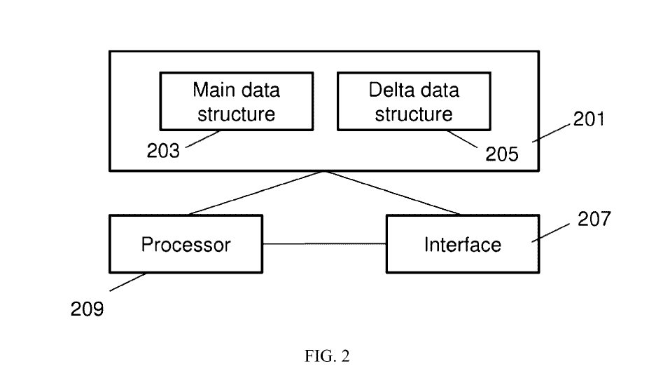

FIG. 2 shows a diagram of a data processing system, comprising a database 201, the database 201 comprising a main data structure 203 for storing database entries and a delta data structure 205 for storing and/or receiving new entries, a communication interface 207 for receiving a plurality of database queries and for receiving new entries, and a processor 209, wherein the processor is configured to aggregate the received plurality of database queries to obtain a batch of database queries, to perform a shared scan of the main data structure with the batch of database queries, wherein the database entries in the main data structure are queried with respect to each database query in the batch of database queries, and, after the step of the shared scan, to merge the main data structure 203 with the delta data structure 205 to update the main data structure 203 with the new entries.

In the following, further embodiments and embodiments of the method and of the system will be described.

Some embodiments solve the following problems: processing mixed workloads of point queries, updates, and complex analytics queries, and achieving high-throughput and meet response time goals.

According to an implementation form, a technique to process high-throughput workloads that are composed of the following three kinds of operations is provided: (1) point queries: accessing an entry or record given its key, (2) point updates: updating an entry or record given its key, and (3) complex queries: carrying out aggregation over a large number of entries or records given different criteria.

The goal is to concurrently process these types of operations, thereby achieving extremely high-throughputs in the range of 100,000s of point queries and updates per second and 100s of complex queries per second by a single machine. Furthermore, the system may be able to maintain different levels of consistency. Furthermore, the system may have to fulfill response time guarantees and other service-level agreements (SLAs).

According to an implementation form, the data fits into main memory and/or can be partitioned in such a way that queries and updates are carried out on each partition separately, the results are aggregated at a separate processing tier, and each partition fits in main memory of a single machine.

According to an implementation form, the point queries and updates are executed using indexes (e.g., hash tables), to execute the complex queries using shared scans, and to avoid cost for synchronization by precompiling a schedule in which all kinds of operations are executed. The precompiled schedule may depend on the isolation level and can be adjusted to the SLAs and the specific workload (volume of each kind of operation). With an increasing load of point queries and updates, for instance, the execution of these operations receives more resources.

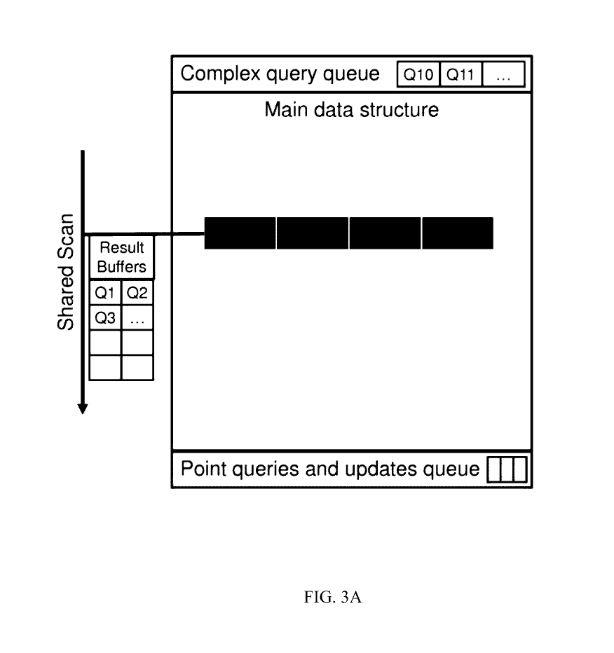

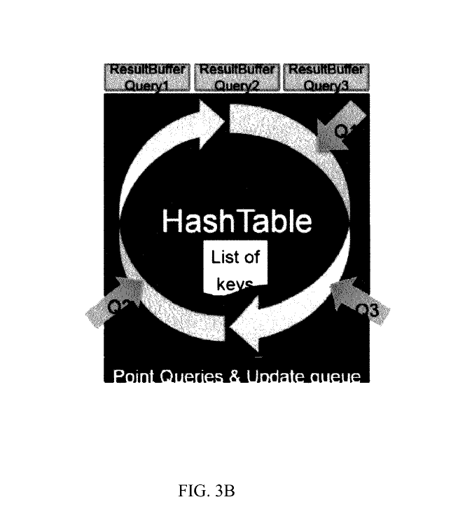

FIG. 3A gives an overview of the components of the system according to an implementation form. On the left are buffers that can keep results that may be processed for complex queries. The predicates and simple aggregates of these queries can be executed using a shared scan through the data. At the top is a queue of newly arriving complex queries that can be processed during a further shared scan, (e.g. the next shared scan). At the bottom is a queue of newly arriving point queries and update operations. These queries and updates may be executing using hash tables on the keys used in the predicates of these queries and updates. Point queries and updates that are not indexed can be processed in the same way as complex queries as part of a shared scan.

According to an implementation form, the approach enables that complex queries, point queries and updates are scheduled. FIG. 3A shows a scenario in which complex queries, point queries and updates can be executed in batches in order to meet SLAs.

FIG. 3B gives an overview of the components of the system according to an implementation form. At the top are buffers that keep results that may be processed for complex queries. The predicates and simple aggregates of these queries are executed using shared scans through the data. At the bottom is a queue of newly arriving point queries and update operations. These queries and updates may be executing using hash tables on the keys used in the predicates of these queries and updates. Point queries and updates that are not indexed are processed in the same way as complex queries as part of a shared scan. The approach depicted in FIG. 3B may also be applicable for individual scans and may optionally be applied.

According to an implementation form, the approach enables that complex queries and point queries and updates are scheduled. FIG. 3B shows a scenario in which queries are executed as soon as they arrive whereas point queries and updates are executed in batches in order to meet service-level agreements. FIG. 3B illustrates that during a shared scan, for each data entry, one query after another can be processed.

The scheduling of operations can also impact the supported isolation level. If queries are batched, too, then snapshot isolation can be achieved. As compared to traditional schemes, which synchronize operations by monitoring the access of each operation to the data, the embodiments disclosed herein schedule operations upfront in such a way that they do not conflict. Furthermore, serializability via locking or optimistic concurrency control can be implemented in the same way as in traditional database systems.

In an embodiment, for complex join queries, the effects of joins between the dimension tables and the fact table are pre-computed to generate a set of keys on the fact table to filter out all tuples that are relevant for the complex query. This pre-computation is done in a separate layer of processing nodes that contains copies of the dimension tables which are assumed to be rarely updated. This way, this pre-computation does not consume resources of the shared scan/hash tables which are the bottleneck of the entire system.

According to some embodiments, the following points are provided: scheduling different classes of operations separately and executing them in batches in order to meet specific response time, throughput, and consistency/isolation requirements for each class of operation, using a combination of shared scans and indexes to execute a batch of operations for each class of operations, and possibly interleaving the execution of batches of different classes of operations.

According to some embodiments, it is possible to establish queues for each class of operation, (i.e., point queries, point updates), and analytic queries. Then, schedule the execution of a whole batch of operations depending on the response time goals of that class of operation is performed. For instance, all point queries can be executed that are queued in the “point queries queue” twice as often as analytic queries. This way, tighter response time goals for point queries may be achieved. Furthermore, best possible methods to execute each class of operations, (e.g., shared scans for analytic queries and hash tables for point queries) can be used. Furthermore, the execution may be interleaved. That is, point queries and point updates may be executed together in a shared way, thereby making use of the same hash table and improving cache locality of lookups to the hash table.

According to some embodiments, the technique may be implemented as part of the Analytics In Motion system (AIM). AIM is a real-time decision system that is part of a customer relationship management (CRM) system of a telecommunications (Telco) operator. The sub-system needs to sustain a mixed workload of concurrent feeds from billing system and several different queries submitted by users of the CRM system. The sub-system is divided into two parts. First, the Stream and Event Processing System (SEP) that processes and stores events in a fashion tailored towards fast evaluation of business rules, and second, the Real-time Analytics System (RTA) that evaluates more complicated analytical queries. AIM does not follow the traditional data warehousing techniques where RTA would be fed by SEP by continuous Extract, Transform, Load (ETL) operations, but can let RTA directly access SEP's storage and thereby makes it able to answer analytical queries in real-time. To validate the performance of the AIM system, two benchmarks can be used: (a) the SEP benchmark and (b) the RTA benchmark. Running both benchmarks concurrently in AIM results in a mixed workload as defined in the problem statement of this document. In the following, further embodiments and implementation forms of the method and of the system are described with respect to the embodiments relating to AIM for event processing and RTA on high frequency streams.

Many enterprises collect large amounts of data that need to be aggregated and analyzed in order to get real-time insights into their businesses. If decision support is desired to be real-time and event rates are huge, the traditional data warehouse approach hits its limits, which calls for a new class of integrated solutions. AIM is an architecture that integrates stream processing and decision support on the same distributed key-value store. Embodiments of the present disclosure relate to a system based on the outcome of these studies and for a specific workload in the telecommunications industry. The system scales from 30 gigabytes (GB) up to 300 GB of analytical data, thereby accommodating high-volume event streams ranging from 10,000 up to 100,000 events per second and allowing to answer up to 100 real-time analytical queries per second with less than 100 milliseconds response time.

Many of the present data-centric flows in the telecommunications industry start with a high-volume stream of events (often represented as variations of detail entries or records) that are generated by probes scattered in the managed network. These events can be processed in real-time in order to maintain the state of the network as represented by numerous indicators. Of particular importance are key indicators that are computed per master entities such as subscribers and cells (e.g., total calls duration per day per subscriber, dropped call ratio per cell). Recently, new scenarios have emerged where there is a need to compute aggregated queries over the network state, abstracted as a table of indicator-per-master-entity, along varying analytical dimensions in real time. In other scenarios, there is a need to compute ad-hoc real-time analytical queries over the indicators table.

This hybrid workload of high volume of updates (events) together with analytical queries can pose a tough challenge to traditional database practices. The traditional practice of separating the Online Transaction Processing (OLTP)-like event processing systems and Online Analytical Processing (OLAP) systems may not answer the real-time nature of such scenarios and may be too expensive and complicated to be considered.

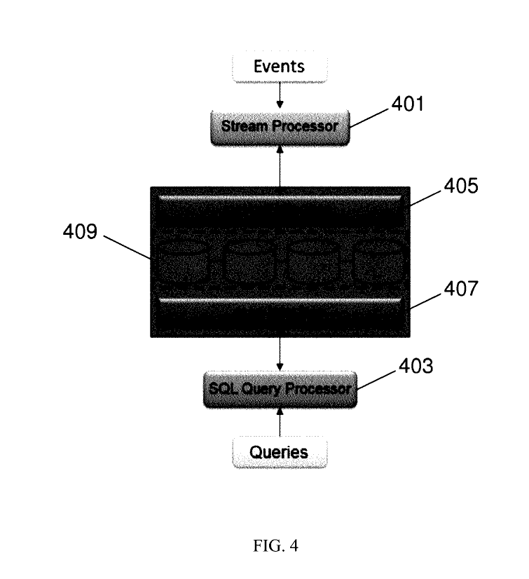

FIG. 4 shows a diagram of a system for querying and updating entries in a database according to an implementation form. The system forms a possible implementation of the system as described in conjunction with FIG. 2.

The system comprises a stream processor 401, a Structured Query Language (SQL) query processor 403, a get/put interface 405, a scan interface 407, and a distributed key-value store 409. The database 201 can comprise the distributed key-value store 409. The communication interface 207 can comprise the get/put interface 405, and the scan interface 407. The processor 209 can comprise the stream processor 401, and the SQL query processor 403.

In order to cope with the new real-time hybrid workloads, this approach explores an architecture referred to herein as AIM. Embodiments of the system according to the AIM architecture are denoted as AIM systems in the following. An AIM system can integrate the data stream processor 401, the distributed key-value store 409, and the SQL query processor 403 as shown in FIG. 4.

In this architecture, the stream processing component processes updates and new events. This way, the data is anonymized and aggregated on the fly. The SQL query processor 403 evaluates complex decision support queries. The stream processor 401 reads and updates entries or records from the store and the SQL query processor 403 carries out bulk queries on the shared distributed key-value store 409. The shared distributed key-value store 409 is implemented as a distributed key-value store 409, which means that all data may only be stored once (e.g. in main memory). Also the stream processor 401 and the SQL query processor 403 can be distributed. This means that update and event processing and decision support can scale independently in such a way that different throughput and response time guarantees can be achieved for each class of workloads. Finally, an important advantage of this architecture is that the stream processor 401 and SQL query processor 403 can be completely stateless, which can simplify achieving fault tolerance.

While the architecture of FIG. 4 has a number of advantages, it can also impose a number of new challenges. One particular challenge can be to implement the storage manager in such a way that it can sustain both the read/update workload of the stream processor 401 and at the same time the bulk read workload of the SQL query processor 403. Another challenge can be the synchronization of the reads and updates in the storage component, e.g. the distributed key-value store 409, thereby meeting different levels of consistency. In addition, separating the components can increase latency and communication costs. Further challenges are specific to the stream processor 401 and SQL query processor 403.

The purpose of this approach can be to describe solutions to address all these challenges. Disclosed herein is a unique main-memory database that can be capable of handling exactly the types of hybrid real-time workloads mentioned above. This database can incorporate many of the ideas presented herein. In addition, the system was evaluated using a realistic workload that abstracted a scenario from a customer. While the need for a system that provides powerful mechanisms to process data on the fly is particularly pronounced in the telecommunications industry, the techniques described herein are more general and apply to many verticals.

In the following, an overview of the AIM system is provided. First, a running example is provided, followed by a description of the components Analytical Matrix, SEP subsystem, and RTA subsystem, with respect to this example. In the end, the optimization goal that AIM is designed to achieve is provided. This optimization goal can be based on specific throughput, latency and freshness specifications.

The AIM architecture can be sufficiently general to address a wide range of applications, like for example processing of telecommunication billing events, on-line shopping, data center management or financial transaction management. In the following, a single use case that motivated this work and to which is referred to herein as the use case as it comes from one of our customers. While the stage for this use case has already been set in the introduction, it is described in some more detail in the following.

The data that may be processed in the use case is billing information and is in no way comparable to the kind of intelligence data that intelligence services may be gathering. Traditionally, this billing data is stored in the data warehouse of a mobile phone operator and is used to implement marketing campaigns, such as offering discounts or new calling plans to loyal customers. The goal is to make this analysis more extensible so that customers can benefit immediately from such marketing campaigns. Typical marketing campaigns and analytical queries do not depend on single events (e.g. caused by phone calls, messages, or network requests), but on summarizing statistics per master entity (i.e. per subscriber or per cell). All the statistics of an entity can be held in an entity entry or record which can be part of huge materialized view that is referred to herein as the Analytical Matrix. An example of an Analytical Matrix that focuses on subscribers and phone calls is depicted in the following table 1.

TABLE 1

| subscr- | no. calls | total duration | total cost | |
|---|---|---|---|---|
| ID | today | today | today | . . . |
| 134525 | 3 | 1921 secs | $7.50 | . . . |
| 585210 | 10 | 3201 secs | $13.80 | . . . |
| 346732 | 0 | 0 secs | $0.00 | . . . |

The Analytical Matrix can be wide, for an average mobile operator it may contain about 500 attributes. These attributes can be a Cartesian product of a set of event properties (e.g. cost, duration, local/long-distance call, preferred number), a set of aggregation functions (e.g. count, sum, average, minimum, maximum) and a set of aggregation windows (today, this week, this month, etc.). Maintaining the Analytical Matrix as a materialized view can mean to process updates on a wide, but nearly constant-size table. In some countries, the telecommunications market is regulated and it is prohibited to gather statistics about single subscribers. In that case, AIM can employ user groups (e.g. based on cell-id, contract-type, age, etc.) which are a sufficient measure of anonymization.

The design of the Analytical Matrix allows for fast processing of queries that ask for statistics of a specific subscriber. However, analytical queries that compute aggregates over several subscribers can incur a full table scan. If the set of possible queries are known in advance, an additional materialized view could be created for each query in order to pre-compute results incrementally. This is exactly how streaming systems and interactive OLTP/OLAP engines like Spark do query processing. In addition, higher-order views can be built on top of lower-order views, as shown in database(DB)-TOASTER. AIM, on the other hand, focuses on ad-hoc queries which may not be known beforehand. This can call for a fast scan.

The first AIM subsystem is called SEP, which receives events, updates the Analytical Matrix according to the aggregation logic and evaluates business rules against the updated entity entry or record. Algorithm 1 shows the pseudo code for updating the statistics of the Analytical Matrix. The function that updates a certain attribute group is denoted as attr group as update_{attr group}. Attribute groups are usually small and contain interdependent attributes, as for example count, sum and average of the the same metric. Steps 3 to 6 may happen automatically which can mean that an entry or record is looked from the Analytical Matrix such that all its attributes are updated and then written back.

Algorithm 1: Updating Statistics

1: function UPDATE_STATISTICS(Event e)
2: UUID id ← get_id(e)
3: Record r ← lookup(id)
4: for all AttributeGroup attr_group ∈ r do
5: attr_group ← updateₐₜₜᵣ_{_{—}}_{group}(e, attr_group)
6: write(id,r)

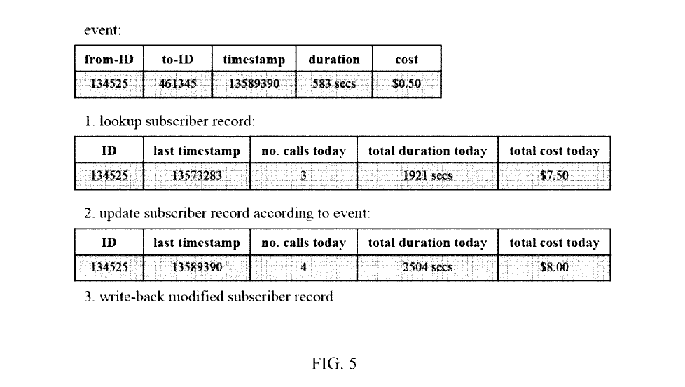

FIG. 5 shows a diagram of an update of a database according to an implementation form. The diagram illustrates an exemplary update of an entity entry or record. In order for the statistics to be correct, it can be desired that the entry or record of entity id has not changed in the meantime. An example execution of the algorithm is illustrated in FIG. 5.

The second important functionality of SEP can be business rule evaluation. This evaluation can happen in real-time, which means that each rule can be evaluated against the updated entity entry or record resulting from a new event. Business rules in a telecommunications billing system are mainly used for marketing campaigns (e.g. rule 1), but could also trigger alerts for potential phone misuse (e.g. rule 2) as shown in the following table 2.

TABLE 2

| nr | rule | action |
|---|---|---|
| 1 | number-of-calls-today > 20 | inform subscriber that the next |
| | AND total-cost-today > | 10 phone minutes today will be |
| | $100 | for free |
| 2 | number-of-calls-today > 30 | advise subscriber to activate |
| | AND (total-duration-today | the screen lock as it appears |
| | / number-of-calls-today) < | that his smart phone is making |
| | 10 secs | calls on its own |

A straight-forward method for rule evaluation is shown in algorithm 2. The method can take as input an up-to-date entity entry or record (e.g. as produced by the event-processing function) and can check it against all rules. Algorithm 2 can assume that rules are in disjunctive normal form (DNF) and are therefore encoded as a list of conjuncts, each of which can contain a list of predicates. Algorithm 2 can feature early abort and early success: (a) whenever a predicate evaluates to false, the whole conjunct can evaluate to false and hence, continue with the next conjunct (lines 7 to 9), and (b) whenever a conjunct evaluates to true, the whole rule can evaluate to true and hence continue evaluating the next rule in the rule set (lines 10 to 12). Note that algorithm 2 can further be optimized.

Algorithm 2: Straight-Forward Rule Evaluation

```
  1: function EVALUATE_RULES(EntityRecord r)
  2: Rule-Set result ← 0
  3: for all Rule rule : rules do
  4: for all Conjunct c: rule.conjuncts( ) do
  5: boolean matching ← true
  6: for all Prdicate p: c.predicates( ) do
  7: if p.evaluate(r) = false then
  8: matching ← false
  9: break
10: if matching = true then
11: result ← result ∪ rule
12: break
13: return result
```

Another AIM subsystem is called RTA Query Processing. The queries processed by that subsystem can be used to answer business intelligence questions (also referred to as decision support). Most of them can be ad-hoc, which means that they may be unpredictable and may involve any subset of Analytical Matrix attributes. In addition to these ad-hoc queries, there can also exist parameterized SQL-like stored procedures, but they may only be a small portion of the workload. Some exemplary RTA queries are shown in the following table. They typically involve many entity entries or records in the Analytical Matrix that can be filtered and aggregated based on some business criteria. What is more, RTA queries might also trigger joins with dimension data (as also referred to herein as Dimension Tables). An example of such a join query is the second query in the following table. RTA queries can be read-only, which can mean that the Analytical Matrix may only be modified by the events that are streamed through the system.

TABLE 3

| nr | query |
|---|---|
| 1 | SELECT SUM(total-cost-today) |
| | FROM Analytical-Matrix |
| | WHERE number-of-calls-today > 2 |
| | AND total-duration-today > 600 secs. |
| 2 | SELECT SUM(total-duration-this-week), |
| | AVG(total-duration-this-week) |
| | FROM Analytical-Matrix am, Subscriber s, Region r |
| | WHERE am.id = s.id and e.region = r.id |
| | GROUP BY r.name; |

After having described the main AIM components, SLAs that can determine how AIM may be implemented are generated, such as: Maximum Event Processing Time (t_{SEP}): upper bound on how much time the system can take to process an event and evaluate the entire rule set for the updated entity entry or record, Minimum Event Processing Rate (f_{SEP}): lower bound on how many events the system may process per entity per hour, Maximum RTA Query Response Time (t_{RTA}): upper bound on how much time the system can take to answer a RTA query, Minimum RTA Query Rate (f_{RTA}): lower bound on how many RTA queries the system may answer per second, and Freshness (t_{fresh}): an upper bound on the time that it takes from the moment an event enters the system until the time when the affected entity entry or record is visible to RTA queries.

Having defined all these SLAs, the optimization goal that AIM is designed to achieve can be formulated as follows: Given a set of statistics to maintain, a set of rules to evaluate and an expected event arrival rate, perform stream and event processing as well as ad-hoc analytical query processing in a way that the given SLAs are satisfied and the number of computing resources per entity are minimized. This can mean that instead of optimizing for a particular throughput or response time, an AIM implementation may guarantee a certain service quality, but within these bounds should minimize the number of machines needed.

The separation of the AIM system into SEP and RTA subsystems can originate from the fact that they serve two different workloads. SEP can handle a high amount of updates (e.g. caused by the events coming at a high rate), which is also referred to as OLTP in the literature. On the other hand, RTA can have a read-intensive (in our case even read-only) analytical workload, also known as OLAP. The traditional solution, motivated by Stonebraker's credo “one size does not fit all” can be to use two different data structures (i.e. two different databases) for the two different workloads, which is known as Data Warehousing. The Data Warehousing approach works very well as long as the data in the warehouse can be outdated by several minutes or hours. However, AIM is used for analytical query processing on “real-time” data, (i.e. data not older than one second). In this architecture, SEP and RTA can share the data structure (i.e the Analytical Matrix) in order to achieve real-time query results. As expected, fitting everything in a single system is a challenge that can involve many subtle design options and decisions to be made.

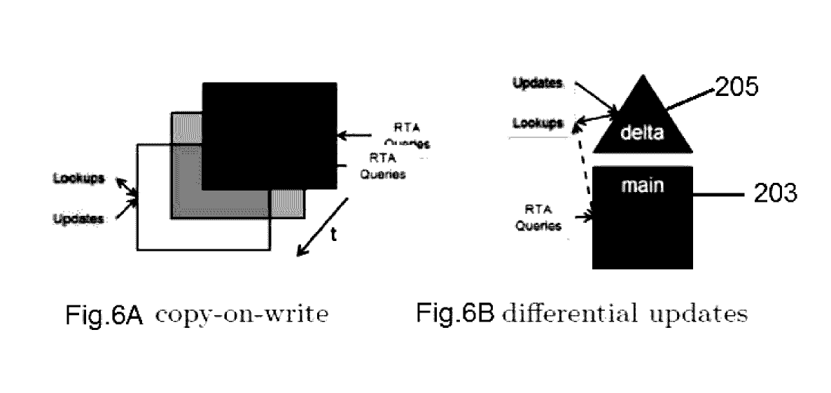

FIG. 6 shows a diagram of an update and a querying of a database according to an implementation form. The diagram illustrates a separation of an update from a query processing. The diagram shows a main data structure 203 and a delta data structure 205.

Although a single database or store is shared by SEP and RTA, there remains a challenge of how to process updates in a way that they do not interfere with longer-running analytical queries. Two different solutions are proposed to solve this challenge, both of which are shown in FIG. 6. Copy-on-write, also referred to as lazy-copying, can be a mechanism employed by most modern operating systems to efficiently manage an initially common memory state of parent and child processes after a fork system call. Systems like HYPER may use this mechanism to manage different snapshots of their database. While updates are processed by the parent process on the most current version of the data, analytical query processing happens in the child processes on an older snapshot. If single entry or record lookups should always return the newest version (e.g. as desired by the SEP subsystem), they can be performed in the parent process.

Differential updates can be a further mechanism. The idea is to accumulate all incoming updates in one data structure (called delta data structure 205) and to process analytical queries in a separated structure (called main data structure 203). Periodically, the updates in the delta data structure 205 can be applied to the main data structure 203, which is referred to as merge. If response time for updates is critical, two delta data structures can be maintained, one for new updates and one for updates currently being merged, and automatically switch them at the point of merge. This approach can also guarantee a snapshot isolation for the analytical queries as they may work on a slightly outdated, but consistent version of the data.

The AIM system can employ a modified differential updates technique instead of copy-on-write, the rationale for this being that the SLAs on SEP may be so rigorous that a fork might block updates for too long. A way to validate our hypothesis is an experimental evaluation, which may make it a priority on our list of future research.

As stated, the architecture can feature a database 201, e.g. a distributed key-value store 409, which means that it can support get and put functionality, i.e. single entry or record lookups and updates. In addition to that, the database 201, e.g. the distributed key-value store 409, can support a fast data scan in order to achieve reasonable throughput and response time for RTA processing, which can raise the question of how to best utilize the available central processing units (CPUs). Two options are identified: (a) process RTA queries in a multi-threaded way, (a) employ a separate scan thread for each incoming query and possibly use a thread pool for recycling, and (b) partition the data, thereby assigning one scan thread for each partition. Incoming queries can be batched and then processed by all scan threads in parallel in a shared scan.

An alternative to a fixed thread-partition assignment can be to partition the data into many small chunks at the start of a scan and then continuously assign chunks to idle threads until every chunk is processed. This can be a simple load-balancing mechanism (e.g. overcoming the problem that partitions could become imbalanced), which may come at an additional cost of chunk management.

The more layers the system has, the more flexible it may be. On the other hand, having fewer layers can reduce network latency and can make the system faster. There can be different options of how to physically place the three architecture components shown in FIG. 4. Although logically separated, it may be an option to place SEP, RTA and the distributed key-value store 409 or storage partition onto the same physical node, referred to herein as the fully integrated approach. This approach can have the advantage of fast data access through the local memory. However, the advantage of the clear separation between database storage and processing may be lost. The fully separated approach (e.g. three separated layers) can be more flexible in the sense that it can allow to provision recourses in a more fine-grained manner (e.g. if faster database storage access may be needed, nodes may be added to the storage layer, leaving the SEP and RTA processing layers unchanged). There can be a wide range of hybrid models that can all lie in between fully integrated and fully separated architecture layering. The AIM system can follow such a hybrid approach in order to get closer towards our optimization goal.

While the Analytical Matrix can be distributed over different storage nodes of the database 201, the question where to store and maintain the rest of the AIM data structures may still remain. It can make sense to place the SEP rules on the same node(s) where the rule evaluation happens, which can mean to replicate the rule set in several places. The more interesting question can be where to place the Dimension Tables and it may be closely related to the question where to do the join processing. Executing joins in the database storage layer can be fast as it can be closer to the data while executing joins in a separate processing layer can allow for more flexibility in the overall design and may be preferable if the storage nodes of the database 201 become overloaded. As the Dimension Tables can be small and static, they could even be replicated at the database storage and at the processing layer. An intelligent query engine on the RTA node can then determine for each query how much of its processing should happen directly in the database storage and how much at the RTA node.

Based on the specific use case description, a benchmark is further described. The benchmark consists of 300 rules, 546 Analytical Matrix attributes, resulting in an entity entry or record size of 3 KB, and seven RTA queries. After the benchmark, the AIM system is implemented for the SLAs shown in the following table 4.

TABLE 4

| | |
|---|---|
| t_{SEP}: 10 msecs | f_{SEP}: 3.6 |
| t_{RTA}: 100 msecs | f_{RTA}: 100 |
| t_{fresh}: 1 sec | |

The system can scale well for a number of entities between 10 and 100 million (M). Apparently the 3.6 events per entity can translate to 10,000 events per second (for 10M entities) up to 100,000 events per second (for 100M entities), producing update volumes of e.g. 30 to 300 MB per second in the Analytical Matrix.

The goal of the system can be to support the claim that a “one fits it all” solution is indeed possible for this specific scenario. As such, the AIM system can be used as a standalone application with which users can communicate through TCP sockets or RDMA (e.g. using InfiniBand).

General observations about the AIM architecture include the following: (a) the OLTP workload (e.g. generated by the event streaming) can consist of single entry or record updates always referring to the primary key (e.g. entity-id) such that the exact position of an entry or record to be updated is known, (b) the Analytical Matrix can use the same primary key and can hence easily be horizontally partitioned in a transparent way, (c) RTA queries may be read-only and can therefore be executed on a read-only snapshot of the Analytical Matrix, (d) rules and dimension tables may be static and can be safely replicated.

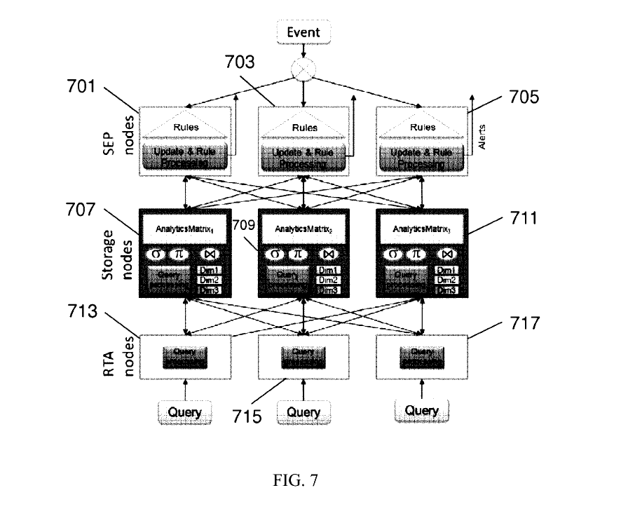

FIG. 7 shows a diagram of a system for querying and updating entries in a database according to an implementation form. The system comprises SEP nodes 701-705, storage nodes 707-711, and RTA nodes 713-717. The system forms a possible implementation of the system as described in conjunction with FIG. 2. The database 201 can comprise the storage nodes 707-711. The processor 209 can comprise the SEP nodes 701-705, the storage nodes 707-711, and the RTA nodes 713-717 in a distributed manner. The communication interface 207 is not shown in FIG. 7.

The diagram illustrates the 3-tier architecture of the AIM system. It can be seen as a special client-server architecture wherein the storage components, e.g. the storage nodes 707-711, can act as a server, and the RTA nodes 713-717 and SEP nodes 701-705 can act as clients. In an embodiment, a dedicated storage layer can be used to store the data structures. As such, the Analytical Matrix and the Dimension Tables can be hosted. Note that the Analytical Matrix can be distributed (i.e. horizontally distributed on the entity-id) overall storage nodes 707-711, while Dimension Tables can be replicated at each node. Distributing the Analytical Matrix can be beneficial to speed up the RTA query processing by scanning the Analytical Matrix in parallel on different nodes. However, to reduce communication cost between server and clients, replicating dimension data at each storage node 707-711 may allow joins to be performed locally. This can be valid because the dimension tables can be assumed to be static.

At the bottom of FIG. 7, the RTA nodes 713-717 can be lightweight processing nodes that can take a query, can redirect it to all storage nodes 707-711 and later on merge the partial results before delivering the final result to the end user. As the bigger part of the RTA query processing can happen on the storage nodes 707-711 anyway, much less RTA nodes 713-717 may be used than storage nodes 707-711.

On top of the storage nodes 707-711 are the SEP nodes 701-705. In contrary to the lightweight RTA nodes 713-717, they can be heavyweight processing nodes that may use the storage nodes 707-711 only for looking up and writing back entity entries or records.

Each SEP node 701-705 can be responsible for a subset of entities, in other words, an event can be routed to the corresponding SEP node 701-705 based on the entity that created it. Each SEP node 701-705 can have a copy of the entire rule set and may use a rule index in order to make evaluation faster.

Communication between SEP nodes 701-705 and storage nodes 707-711 can happen synchronously (e.g. using the get/put interface 405), while communication between RTA nodes 713-717 and the storage nodes 707-711 can be asynchronous (e.g. answers are sent whenever they are available). Although the INFINIBAND technology may be preferred to communicate, a Transport Control Protocol (TCP) socket communication module was also implemented in order to make our system work on systems that do not support INFINIBAND.

Despite the fact that the logical design of the AIM architecture is 3-tier, it may not imply that the physical design has 3 tiers as well. In fact, two configurations for the SEP-storage layout and interaction were tested: (a) separate physical tiers and communication over INFINIBAND and (b) placement at the same physical machine (e.g. on different cores) and communication through common memory structures. While (a) can be very beneficial in terms of flexibility of the whole system, (b) can help to tweak the system for the last bit of performance to avoid sending large (e.g. 3 kilobyte (KB)) statistical entries or records over the network.

Recalling algorithm 1, each attribute of the Analytical Matrix can have its own, customized update function. This can make updates much faster than using a generic update function. Such a function can contain a lot of switch statements slowing down the execution because of branch mispredictions in the CPU. In order to make the programming of tailored update functions easier and more flexible, they can be composed in a modular way such that common characteristics (e.g. window semantics) can be shared. As stated, each attribute can be an element of the Cartesian product of event-attribute×aggregation-function×time-window, time-window itself being a combination of window type and window interval. That can mean that a large number of update functions can be created from the composition of a few small building blocks.

Making these building blocks templated can allow the compiler to create very efficient update code. At system startup time, the information about Analytical Matrix attributes can be loaded from a meta-database (e.g. that defines the setting of the system) and create an array of function pointers which can be used to update statistics. Updates can thus be fast because (a) each attribute can be updated by following the corresponding function pointer, which can make branch prediction possible, and (b) the compiler-generated composed update functions may not contain any conditional jumps.

As the rule set can be fixed and known in advance, it can make sense to consider indexing the rules in order to make index evaluation fast. Therefore, a rule index may be implemented based on the ideas of Fabre, et al. However, it turns out that for 300 rules that are in the benchmark, this index may not be faster than just processing rules without index in a straight-forward manner with early loop termination as shown in algorithm 2. A micro-benchmark where the number of rules are varied (e.g. each of which consists of 5 conjuncts and 5 predicates per conjuncts on average, varying from 1 to 10) and found out that using a rule index started paying off for a rule set size of about 1000 and above. As long as the rule set is relatively small, complexity can be reducedand therefore not use any index at all.

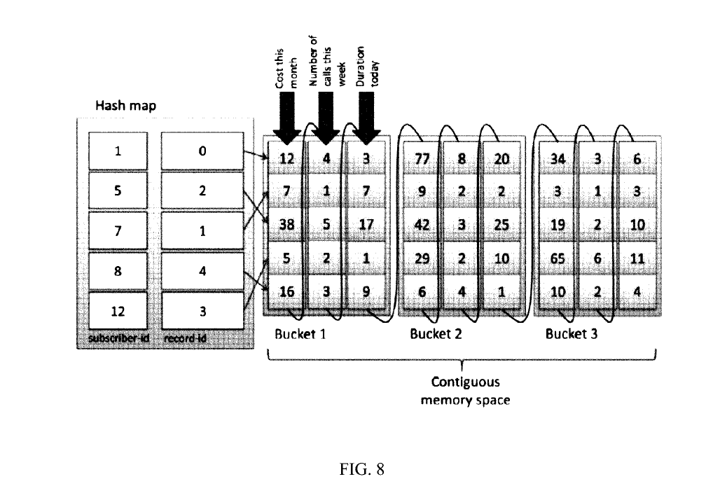

FIG. 8 shows a diagram of a hash table according to an implementation form. The hash table can comprise a ColumnMap.

As suggested, the Analytical Matrix can be implemented within a database 201, e.g. a distributed in-memory key-value store 409. Preliminary experiments show that for achieving the SLAs of SEP, RAMCLOUD can work well as a key-value store. RAMCLOUD may not only provide fast entry or record lookups and writes, but can also support durability and fault tolerance as it follows a log-structured design. However, as can be true for any row store, a fast enough scan speed for RTA query processing may not be achieved and therefore, alternatives may need to be searched for when starting to implement the RTA subsystem. In order to get fast scan speed, traditional analytical query processing engines can use a column-oriented database or storage layout, which may not be well suited for high update rates.

The solution to overcome this challenge can be to use the partition attributes across (PAX) approach that can help to find the sweet spot between purely row-oriented and purely column-oriented database or storage layouts. The idea of PAX can be to group entries or records into chunks that fit into a memory page and within a page store group them column-wise, e.g. values of a particular attribute can be grouped together. Analytical queries that process a small subset of the attributes can then profit from data locality as well as the fact that the entire entries or records of a chunk are present in memory at the same time. Therefore, ColumnMap is designed, which is a data structure that can follow this design with the difference that it may be optimized for cache size rather than the size of memory pages as all data structures in the AIM system can be held in the database 201 or memory.

The structure of ColumnMap is exemplified in FIG. 8A fixed number of entries or records are grouped into logical blocks called buckets. In the exemplary system the default bucket size is 3072. As bucket size can be a tuning parameter relating to cache size, 3072 is chosen as being the highest power of two such that a bucket (that has size 3072 times 3 KB) can fit into the 10 MB layer 3 (L3) cache of our hardware.

All buckets combined can hold the entire Analytical Matrix. Within a bucket, data can be organized into columns. Each column can hold the values for a particular subscriber attribute (e.g. cost this month). This approach can allow to increase inter-entry or -record locality, which can be beneficial for scan processing of individual attributes. In addition to the buckets, a small hash map or table can keep track of the mapping between entity-id and entry- or record-id. The reason for this level of indirection can be the fact that entity-ids can be arbitrary numbers while the entry- or record-ids can be continuous numbers starting from 0. Since the entries or records can be of constant size and each bucket can comprise a constant number of entries or records, the address of a specific value can be computed from its entry- or record-id. This can make lookups for single values fast.

It is worth mentioning that the ColumnMap can be used as a pure row store (e.g. by setting the bucket size to one) or as pure column store (e.g. bucket size=database size). In fact, ColumnMap can outperform a column store with respect to its update performance when entries or records are small enough to fit into a cache line. If they are not (as in our use case with 3 KB entries or records), the bucket size may not play a major role, neither for RTA nor for SEP performance and a pure column-store can be used.

There are two reasons ColumnMap is preferred over using an established column store in the system: (a) it can have a tunable parameter bucket size, which can make it a row, column and hybrid store at the same time and therefore enhances flexibility, and (b) it has direct access to the raw data in the store without the need of going through an SQL interface. While there can be some mentionable exceptions, most available column stores may not expose their internal data structures.

As stated, updates produced by SEP do not interfere with RTA queries because these queries can return a consistent result and therefore work on a consistent snapshot of the Analytical Matrix. In order to solve this challenge, a modified version of differential updates may be implemented. Compared to the original proposition, dictionary compression may not be used as the Analytical Matrix may only contain fixed-size numeric data types. The SEP subsystem may not afford to be blocked at any time (e.g. during the merge-phase), and thus, a new delta data structure 205 may be allocated right before merging, which can mean that there are two delta data structures during the merge phase. Updates and lookups can be adapted accordingly as illustrated by algorithms 3 and 4.

Algorithm 3: Analytical Matrix Update

1: function UPDATE(EntityRecord r, UUID id)
2: if ∃ new-delta then
3: put(new-delta, r, id)
4: else
5: put(delta, r, id)

Algorithm 4: Analytical Matrix Lookup

1: function LOOKUP(UUID id)
2: AMRecord result ←NULL
3: if ∃ new-delta then
4: result ← get(new-delta, id)
5: if result = NULL then result ← get(delta, id)
6: if result = NULL then result ← get(main, id)
return result

These algorithms can test whether variable new delta data structures exist in order to determine whether there is currently a merge being performed (i.e. new-delta exists) or not (i.e. new-delta does not exist). As the algorithms may not be thread-safe, lookups and updates may be performed by one dedicated SEP thread. This decision can allow to update entity entries or records atomically, which can be an important functional specification.

As the delta data structure 205 can be optimized for single entry or record operations using a dense hash map or table. Additionally, the main data structure 203 can feature a fast scan and can be indexed in order for the single entry or record operations to work. The index on the primary key (e.g. the entity-ID) can also be a specification for an efficient implementation of the merge-step as it can mean a single pass can be done through the delta data structure 205 instead of traversing the whole main data structure 203 again. The main data structure 203 can be implemented as ColumnMap which can be in our case an optimal fit as explained.

There can remain the question when and how often a merge step should be performed. In order to prevent the delta data structure 205 from growing too large, it can be beneficial to merge as often as possible. Moreover, merge steps can interrupt RTA query processing and therefore the right moment for merging may have to be chosen carefully. Luckily, the merge step can be interleaved nicely with query processing.

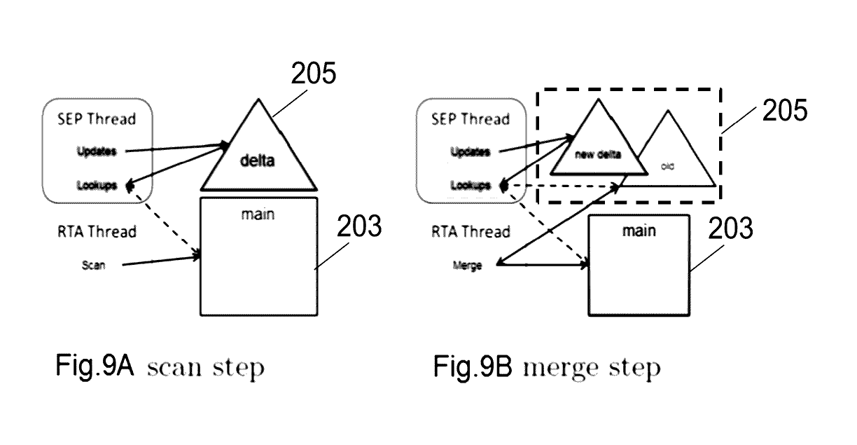

FIG. 9 shows a diagram of an update and a querying of a database according to an implementation form. The diagram comprises a main data structure 203 and a delta data structure 205. The diagram illustrates a collaboration of an SEP thread and an RTA thread.

Conventional database systems can process one query at a time. Inspired by SHAREDDB, a higher through-put can be achieved by using a batch-oriented processing technique instead. The database 201 or storage server can keep a queue of queries that are submitted by the RTA client nodes. Once a new scan is started, the queries in the queue can be processed together in one single scan pass. Such a shared scan can allow multiple queries to share the same scan. This batch-oriented processing technique can reduce undue wait times for individual queries and can allow to increase query throughput. Moreover, the batch-oriented query execution model can nicely fit the delta-main data structure or storage layout because scan and merge steps can be interleaved. An RTA thread can therefore work in a loop with the following two steps as illustrated in FIG. 9.

In the scan step, scan the entire main data structure 203 (e.g. ColumnMap) as shown in algorithm 5. During that phase the main data structure 203 can be read-only and therefore concurrent accesses by the SEP thread (e.g. performing a lookup) and the RTA thread can be safe.

Algorithm 5: Shared Scan Query Processing

1: function SHARED_SCAN
2: for all Bucket bucket : column - map do
3: for all Query query : queries do
4: process_bucket(query)

In the merge step, the RTA thread can scan the delta data structure 205 and can apply the updates to the main data structure 203 in-place. The delta data structure 205 can become read-only as new updates can be redirected to the newly allocated delta data structure. The SEP thread may not read an item that the RTA thread is currently writing to, simply because if an item is currently updated in the main data structure 203, it can mean that it can also exist in the delta data structure 205, which can imply that the SEP can get it from there and not from the main data structure 203, see algorithm 4.

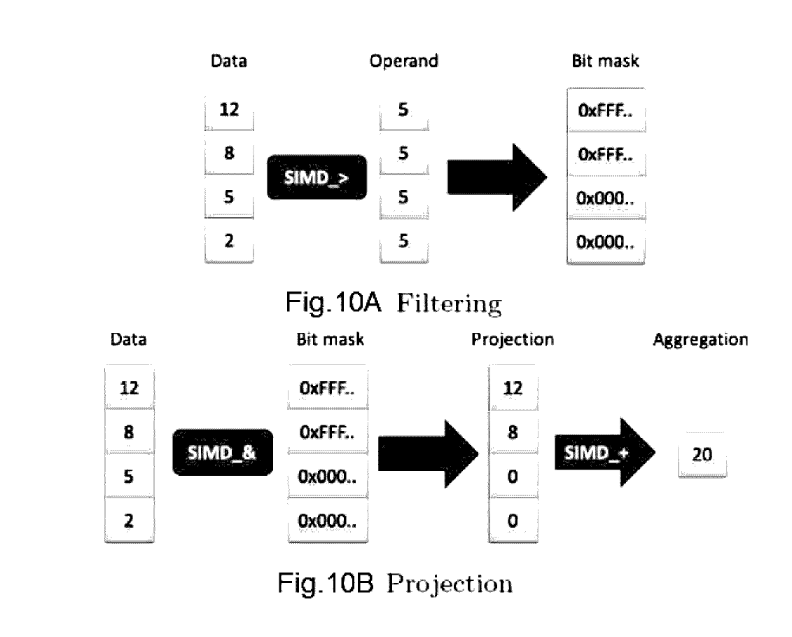

FIG. 10 shows a diagram of a single instruction multiple data (SIMD) processing scheme according to an implementation form. The SIMD processing scheme can be applied by the system as described in conjunction with FIG. 2.

Many processors can feature explicit single-instruction multiple data (SIMD) machinery such as vector registers and specialized instructions to manipulate data stored in these registers. They can allow for one instruction to be performed on multiple data points in parallel. For example, streaming SIMD extensions (SSE) can operate on registers of 128-bit or 256-bit width. The size of these registers can allow to concatenate up to 4 floating-point operands into a single vector and to process arithmetical or logical operations in parallel.

SIMD instructions can allow for a degree of parallelism and can also often lead to the elimination of conditional branch instructions, reducing branch mis-predictions. This can make SIMD instructions very useful for high-performance databases that may be more often CPU bounded than memory bounded due to an increase of Random Access Memory (RAM) capacities. Therefore, SIMD instructions can be exploited to build a fast scan on the database 201, (e.g. ColumnMap). This scan can include filtering (selections) and aggregation (projection) as illustrated in FIG. 10.

Filtering with SIMD instructions can mean to first load a column into one vector register and the operand in the other register and then to perform an SIMD comparison instruction (e.g. SIMD_>), which can result in a Boolean bit mask that states whether to include a value in the result (e.g. value 0xF . . . F) or not (e.g. value 0x0 . . . 0). The bit masks from different filters can be combined by either SIMD_& or SIMD_—according to the WHERE clause of the query. In aggregation, (SIMD_&) the data vector is intersected with the bit mask resulting from filtering and then an aggregation operator (SIMD_MIN, SIMD_MAX or SIMD_+) is applied.

The use case may only involve primary key/foreign key relationships between statistics (e.g. Analytical Matrix) and the dimensional data, which can mean that a join can basically be a lookup in the dimension table. Moreover, dimension tables can be static and small, which can allow to do a special tweak, namely de-normalize the dimension data and store it along with the entity entries or records in the Analytical Matrix. This can mean that the join can be performed only once at creation time of an entity entry or record, which can speed up query execution substantially. As soon as dimension data becomes larger, changes more often or includes many-to-many relationships with the Analytical Matrix traditional joins, e.g. hash joins or sort-merge joins, may be implemented.

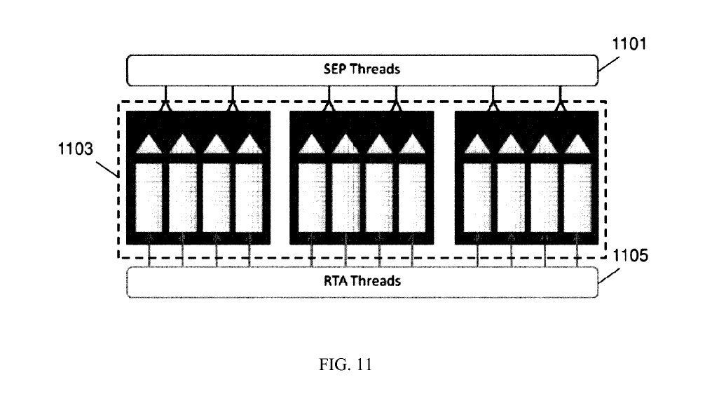

FIG. 11 shows a diagram of a system for querying and updating entries in a database according to an implementation form. The diagram comprises SEP threads 1101, partitions 1103 of an Analytical Matrix, and RTA threads 1105. The diagram illustrates the partitions 1103 of the Analytical Matrix and a thread model with s=2, n=4, and k=2. The Analytical Matrix and the thread model can be realized within the system as described in conjunction with FIG. 2.

As explained, the Analytical Matrix may not only be distributed over different nodes, but also partition it further within a node as shown in FIG. 11. There may be two parameters that can determine resource provisioning: the number of SEP threads s and the number of RTA threads n which can equal the number of data partitions 1103. Each RTA thread can be related to exactly one data partition while each SEP thread can work on the delta of several (up to k) partitions 1103. First, an s that is large enough that the SLAs on SEP can be achieved is chosen, and then the remaining cores for RTA processing and communication (e.g. 2 threads for communication with the other 2 tiers) are used, which can mean n=number-of-cores−s−2. Note that the terms core and thread are used interchangeably here because there may be as many threads as cores in order to avoid a performance degradation of over-subscription.

Routing a lookup or an update request to the correct partition can work as follows: first, use a global hash function h to route the request to the node with ID h(key). Next, within the node apply a node-specific hash function hi(key) to determine the ID of the partition that hosts this key. Finally, route the request to the SEP thread responsible for this data partition.

The distribution of data can raise the question of consistency. Intra-node consistency can be implemented by coordinating the start of the scan-step for all RTA threads 1105 on a storage node. This can also be beneficial because if all thread start at the same time, they can work on the same query batch. Inter-node consistency may not be provided as events may not have a global order. Distributed transactional consistency can be a complex task that can be subject to research.

The following table 5 illustrates RTA queries 1 to 7, wherein α in [0; 2], β in [2; 5], γ in [2; 10], δ in [20; 150], tin SubscriptionType, c in Category, and v in CellValue.

TABLE 5

```
Query 1:
SELECT AVG (total_duration_this_week)
FROM AnalyticsMatrix
WHERE number_of_local_calls_this_week > α;
Query 2:
SELECT MAX (most_expensive_call_this_week)
FROM AnalyticsMatrix
WHERE total_number_of_calls_this_week > β;
Query 3:
SELECT (SUM (total_cost_this_week) /
    SUM (total_duration_this_week)) as cost_ratio
FROM AnalyticsMatrix
GROUP BY number_of_calls_this_week;
Query 4:
SELECT city, AVG(number_of_local_calls_this_week,)
    SUM(total_duration_of_local_calls_this_week)
FROM AnalyticsMAtrix. RegionInfo
WHERE number_of_local_calls_this_week > γ
    AND total_duration_of_local_calls_this_week > δ
    AND AnalyticsMatrix.zip = RegionInfo.zip;
Query 5:
SELECT region,
    SUM (total_cost_of_local_calls_this_week) as local,
    SUM (total_cost_of_long_distance_calls_this_week)
      as long_distance
FROM AnalyticsMatrix a, SubscriptionType t,
    Category c, RegionInfo r
WHERE t type = t AND c.category = c
    AND a.subscription_type = t.id AND a.category = c.id
    AND a.zip = r.zip
GROUP BY region;
Query 6:
report the cell-ids of the records with the longest call this
day and this week for local and long distance calls for a
specific country
Query 7:
report the cell-ids of the records with the smallest flat rate
(cost of calls divided by the duration of calls this week)
for a specific cell value type v
```

As illustrated, the AIM system can address a specific use case, which can call for a specific benchmark. First, a benchmark is defined that can test the ability of the system to cope with the specifications of the use case. The benchmark consists of 300 rules, 546 statistics (that means entity entries or records of roughly 3 KB) and seven different parameterized RTA queries. While queries 1 to 3 may work on the statistics only, queries 4 to 7 can involve joins with one or several Dimension Tables. For space reasons, details about the Dimension Tables are omitted and Q6 and Q7 are described only in textual form as the full SQL statements can involve nested complex sub-queries. The benchmark parameters are number of entities (i.e. volume of statistical data), event rate, number of RTA client threads c and query-mix. The events are sent at a fixed rate, and the RTA queries are run in closed loops (where a thread may only send a query after having received and processed all partial results from the previous query).

This means that the RTA load is increased on the system by increasing c. As the use case states that the system may be able to answer ad-hoc queries, the workload may be unpredictable. In order to model this, the use of any indexes on the statistics are disallowed, except for the primary key.

The experiments are conducted on servers equipped with a dual-socket 4 core XEON E5-2609 CPU, each core operating at 2.40 GHz. Each server features 32 KB layer 1 (L1) cache, 256 KB layer 2 (L2) cache and 10240 KB layer 3 (L3) cache as well as 4×32 GB double data rate dual in-line memory module (DDR3-DIMM), resulting in a total of 128 GB RAM. A standard LINUX 4.6.3-1 running kernel 3.4.4 is used, and a general communications channel (GCC)-4.7.2 and communicated over INFINIBAND. As illustrated, the host SEP nodes and storage nodes are hosted on the same physical nodes (e.g. communicating through shared memory) and thin RTA processing nodes separately. One dedicated machine may be used for generating random events and measuring end-to-end throughput and response time of the event processing. This machine can be configured to send events at a certain rate (e.g. as specified by the benchmark). The creation of random RTA queries and end-to-end measurements of throughput and response time are executed directly on a single RTA node with c threads, which can work well because it was not fully utilized by RTA processing activities.

As stated, the AIM system may be able to cope with an event rate of 3.6 events per entity per hour and scale from 10M to 100M entities. First, a number of experiments may be executed to determine the optimal resource allocation and parameter setting for 10M entities and 10,000 events per second and then steadily increased the number of entities up 100M. All experiments are conducted using a query mix of all seven queries, drawn at random with equal probability. Average end-to-end response time and overall query throughput of RTA queries are reported. As the event rate can be configured to meet f_{SEP}, only measured SEP throughputs that deviated from the event rate are reported. t_{SEP} is always met and is therefore omitted from the results. The following default values were used for the experiments: 10M entities, 10,000 events/sec, 8 RTA client threads (c=8), 1 SEP server thread (s=1), 5 RTA server threads n=5 (=number of data partitions), 1 AIM server.

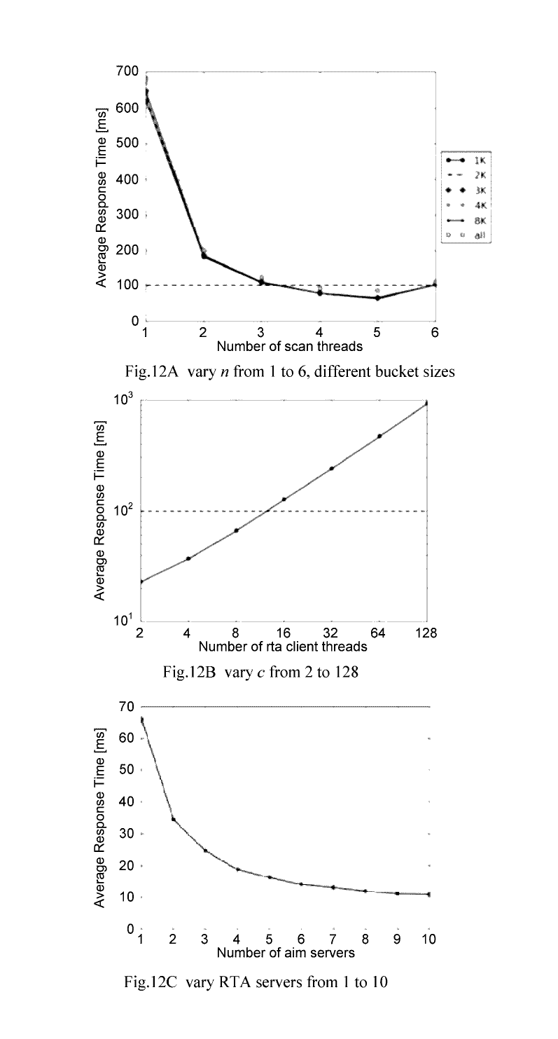

FIG. 12 shows performance diagrams of a system for querying and updating entries in a database according to an implementation form. The diagrams illustrate an average response time of RTA queries in msec for 10M entities, 10,000 events/sec, in a default configuration comprising 1 server, n=5, and c=8.

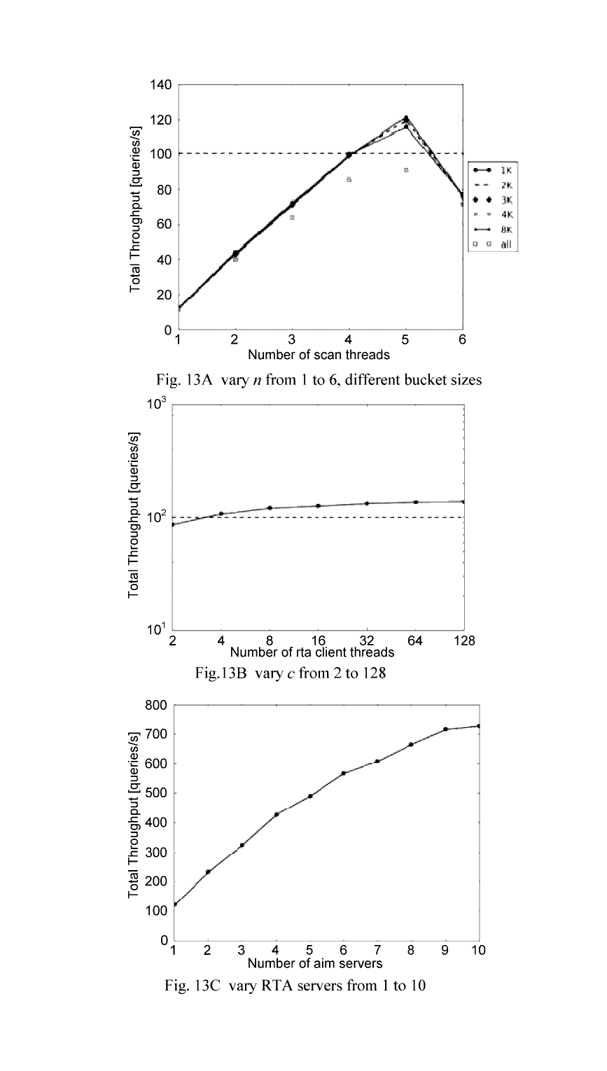

FIG. 13 shows performance diagrams of a system for querying and updating entries in a database according to an implementation form. The diagrams illustrate a throughput of RTA queries in queries/sec for 10M entities, 10,000 events/sec, in a default configuration comprising 1 server, n=5, and c=8.

A preliminary experiment shows that one single SEP thread can handle up to 15,000 events per second, which is more than enough for serving 10M entities and is the number of SEP threads is fixed to one. FIGS. 12A and 13A show response time and throughput for different numbers of storage partitions (=RTA server threads) and different bucket sizes on a single storage server. As hypothesized, optimal performance when allocating exactly as many threads as there are cores are obtained. As there is one SEP thread and two communication threads, this results in 5 RTA server threads on an 8-core machine. Moreover, with 4 and 5 partitions, all SLAs are met (merge is performed after each scan and therefore t_{fresh} is in the same magnitude as response time and therefore clearly below 1 sec). For n=6, the SEP throughput falls below 10,000 to about 8,000 events/sec for the different bucket sizes, which is a direct consequence of the thread thrashing at the storage nodes. Therefore, bucket size does not seem to have an impact on performance as long as it is large enough. Notice that the ColumnMap outperforms the pure column store (which is referred to as all).

As the execution time of a shared scan can be dominated by the execution time of the heaviest query in its workload, it can be good to know the average response time of each query in isolation, which is shown in the following table. The results suggest that an optimization could be to batch queries in several groups according to their expected response time. The following table 6 illustrates query response times in msec, with n=5, and 3K-buckets.

TABLE 6

| Q1 | Q2 | Q3 | Q4 | Q5 | Q6 | Q7 |
|---|---|---|---|---|---|---|
| 9.57 | 73.2 | 68.7 | 17.5 | 123 | 82.2 | 73.8 |

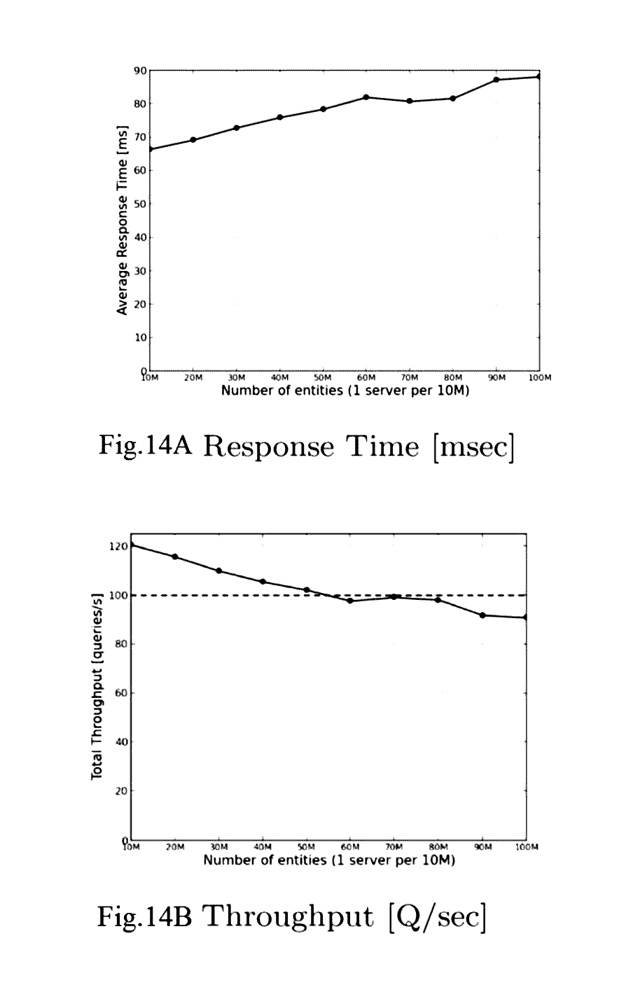

FIG. 14 shows performance diagrams of a system for querying and updating entries in a database according to an implementation form. The diagrams illustrate a variation of RTA servers and a load.

As the threads of the RTA processing node can work in a closed loop, their number can also be an upper-bound on the query batch size at the storage server(s). To test the robustness of the system, simply increase the RTA load by varying c from 2 to 128 as shown in FIG. 12B and FIG. 13B. The system can be robust in the sense that once saturation is reached (e.g. somewhere around 54 threads) it stays constant but does not drop, while response time increases linearly, but not exponentially, as expected. The fact that we satisfy both RTA SLAs (e.g. t_{RTA}<100 msecs and f_{RTA}>100 q/sec) with 8 threads can suggest to limit query batch size at the storage server at about 8.

In order to compare the AIM system to a high-performance general-purpose database, the storage component in the robustness experiment is replaced by a POSTGRES database. In order to make the comparison as fair as possible POSTGRES is tweaked to run in main-memory by using a RAM disk. Moreover, f_{sync} and synchronous_commit are turned off and increase wal_buffers according to the size of the Analytical Matrix. In addition, seq_page_cost and random_page_cost are decreased to a considerable limit, taking into account that we operate on a RAM disk. Despite all these approaches, POSTGRES may not meet the specified SLAs. An SEP throughput of 828 events per second is measured for the best configuration (c=2).

RTA performance can best be reached with c=4. This is a total throughput of 0.16 queries per second and query response times ranging from 3 msecs (Q6) to 65.7 secs (Q3). The good result of Q6 can be explained by the fact that indexes on the relevant attributes are used despite the benchmark forbidding this. The performance of POSTGRES can be explained by the fact that each incoming event can incur a large number of column updates (e.g. more than 500 attributes) and an overhead of the SQL layer. These can be two challenges that even commercial general-purpose database products can suffer from as they usually disallow direct modification of the raw data.

The previous experiments illustrate that one storage server is enough to accommodate 10M entities. However, as SLAs might change, it can be important to know whether provisioning more resources can solve the challenge. In order to analyze this, increase the number of storage servers is increased from 1 to 10 as illustrated in FIG. 12C, respectively FIG. 13C. A near linear increase is seen in throughput as well as response time. Therefore, it is possible to scale out with a satisfactorily small overhead.

The last experiment concerns scalability, or in other words, how the performance measures change if the number of servers and the load (number of entities, event rate) are increased accordingly. For each added server, 10M entities and 10,000 events per second are added. FIG. 14 shows a decent scalability. Ideally throughput and response time would be horizontal lines. The fact that they are not, shows the increased overhead at the RTA processing node where partial results have to be merged. There may be two options to reduce end-to-end response time in order to improve throughput and make it stay above the desired 100 queries per second: (a) reduce the service time at the storage layer by adding another storage node as suggested by FIG. 12C or (b) speed up the aggregation of partial results at the RTA processing node by parallelization. Option (b) can be favorable whenever RTA processing nodes are under-utilized because already available resources can be used.

There is a variety of work in the field. What differentiates the AIM system from all these other systems are at least two things: (a) the special workload mix of streaming and ad-hoc analytical query processing, and (b) the specific latency specifications (SLAs) that the AIM system may fulfill. While the basic building blocks used in the AIM system implementation (e.g. Data Partitioning, Shared Scan, Differential Updates, SIMD Processing) can be applied, disclosed herein are improvements in the way in which they are combined to achieve the particular specifications that the AIM system is defined for.

On one side of the spectrum, there are conventional streaming engines, like APACHE STORM, ESPER, and STREAMINSIGHT. These systems are good in handling high event rates and computing statistics on them. However, the sheer amount of statistics to be kept in the AIM system (e.g. 500 statistics to be kept for each entity) can pose a challenge on these systems. Preliminary experiments with Storm show it to be away from achieving the desired performance. In addition, a streaming engine may have to be extended in order to allow for query processing.

On the other side, there are fast analytical processing engines, like HANA, C-store, and MONETDB. These systems can speed up query execution by organizing the data column-wise, therefore only examining the interesting attributes of an entry or record. Again, the number of columns in the Analytical Matrix can be a challenge, because an update of an entity entry or record would incur e.g. 500 random memory accesses.

There are alternative ways to implement the Analytical Matrix, which is to use an off-the-shelve key-value store like BIGTABLE, H-BASE, or RAMCLOUD. While these systems can cope with the SEP specifications, it can be an open question how to process analytical queries on top of them. They typically support key- and sometimes value-based accesses, but usually no scan. RAMCLOUD can offer a feature called “enumerate”, but experiments with the AIM system workload show that this is two orders of magnitude slower than the scan implemented for the Analytical Matrix.

Finally, there are OLTP/OLAP engines that may be similar to the AIM system. Among them are SHAREDDB, HYPER, HYRISE, and SPARK STREAMING. These systems typically make the assumption that most of the analytical queries are known beforehand and make use of this by employing a special storage layout (HYRISE), or specialized views (SPARK STREAMING). Ad-hoc queries can be supposed to appear rarely and may therefore not have to meet strict latency specifications. The case for the AIM system is different because ad-hoc queries can be rather the standard than the exception. How HYPER's copy-on-write approach can cope with the AIM system workload is still an open question.

We have described the AIM system, an architecture for addressing systems with stringent SLAs on streaming, frequent updates and execution of analytical queries in real-time. The design space of such an architecture and implemented the AIM system is a distributed and flexible implementation for a specific workload that builds on specific principles, such as the PAX paradigm, efficient distributed super-scalar query execution with SIMD and a new variant of differential updates for real-time data management.

What is more, a comprehensive benchmark that can capture the features of the specific workload of the use case is developed. The experimental evaluation of the AIM system with this benchmark shows that the SLAs (e.g. to process 10,000-100,000 events per second for 10M to 100M entities can be met, resulting in updates of 30 to 300 MB per second and at the same time answer up 100 decision-support queries per second with a response time of 100 milliseconds (msecs)) with minimal resources. This minimal resource allocation features one storage server node per 10M entities.

The following references are further incorporated herein by reference.
Y. Ahmad et al. “DBToaster: Higher-order Delta Processing for Dynamic, Frequently Fresh Views”. In: PVLDB 5.10 (2012), pp. 968-979.
A. Ailamaki et al. “Weaving Relations for Cache Performance”. In: VLDB. 2001, pp.
F. Färber et al. “The SAP HANA Database—An Architecture Overview”. In: IEEE Data Eng. Bull. 35.1 (2012).
M. Aslett. Data Platforms Landscape Map. http://blogs.the451group.com/information_management/2014/03/18/updated-data-platforms-landscape-map-february-2014. Mar. 18, 2014.
P. A. Boncz et al. “MonetDB/X100: Hyper-Pipelining Query Execution”. In: CIDR, Vol. 5, 2005, pp. 225-237.
F. Chang et al. “Bigtable: A Distributed Storage System for Structured Data”. In: ACM Trans. Comput. Syst. 26.2 (June 2008), 4:1-4:26.
F. Fabret et al. “Filtering Algorithms and Implementation for Very Fast Publish/Subscribe”. In: SIGMOD. 2001, pp. 115-126.
G. Giannikis et al. “SharedDB: killing one thousand queries with one stone”. In: PVLDB 5.6 (February 2012), pp. 526-537.
Google, Sparsehash. https://code.google.com/p/sparsehash.
Google, Supersonic Query Engine. https://code.google.com/p/supersonic.
M. Grund et al. “HYRISE—A Main Memory Hybrid Storage Engine”. In: PVLDB 4.2 (2010), pp. 105-116.
Hortonworks, Apache Storm—A system for processing streaming data in real time.
InfiniBand Trade Association, InfiniBand. http://www.infinibandta.org.
D. R. Karger and M. Ruhl. “Simple Effcient Load Balancing Algorithms for Peer-to-peer Systems”. In: SPAA. 2013, pp. 36-43.
S. J. Kazemitabar et al. “Geospatial stream query processing using Microsoft SQL Server StreamInsight”. In: PVLDB 3.1-2 (2010), pp. 1537-1540.
A. Kemper and T. Neumann. “HyPer: A hybrid OLTP & OLAP main memory database system based on virtual memory snapshots”. In: ICDE. 2011, pp. 195-206.
A. Khetrapal and V. Ganesh. “HBase and Hypertable for large scale distributed storage systems”. In: Dept. of Computer Science, Purdue University (2006).
R. Kimball. The Data Warehouse Toolkit: Practical Techniques for Building Dimensional Data Warehouses. John Wiley, 1996.
J. Krueger et al. “Fast updates on read-optimized databases using multi-core CPUs”. In: VLDB 5.1 (2011), pp. 61-72.
S. Loesing et al. On the Design and Scalability of Distributed Shared-Memory Databases. Tech. rep. ETH Zurich, 2013.
J. Ousterhout et al. “The case for RAMCloud”. In: Commun. ACM 54.7 (July 2011), pp. 121-130.
E. Snowden. I don't want to live in a society that does these sort of things. Youtube, http://www.youtube.com/watch?v=5yB3n9fu-rM. Jun. 9, 2013.
M. Stonebraker et al. “C-Store: A Column-oriented DBMS”. In: VLDB. 2005, pp. 553-564.
M. Stonebraker et al. “Object-relational DBMS-the next wave”. In: Informix Software, Menlo Park, Calif. (1995).
E. Tech. Event Series Intelligence: Esper & NEsper. http://esper.codehaus.org.
TELCO-X Network Analytics Technical Questionnaire, internal document relating to customer TELCO-X. 2012.
C. Tinnefeld et al. “Elastic online analytical processing on RAMCloud”. In: EDBT 2013, pp. 454-464.
P. Unterbrunner et al. “Predictable Performance for Unpredictable Workloads”. In: PVLDB 2.1 (2009), pp. 706-717.
T. Willhalm et al. “SIMD-scan: ultra fast in-memory table scan using on-chip vector processing units”. In: PVLDB 2.1 (2009), pp. 385-394.
M. Zaharia et al. “Spark: cluster computing with working sets”. In: Proceedings of the 2nd USENIX conference on Hot topics in cloud computing. 2010, pp. 10-17.
J. Zhou and K. A. Ross. “Implementing database operations using SIMD instructions”. In: SIGMOD. 2002, pp. 145-156.

Although the disclosure is described with reference to specific features and embodiments, it is evident that various modifications and combinations can be made thereto without departing from the spirit and scope of the disclosure. The description and the figures are, accordingly, to be regarded simply as an illustration of the disclosure as defined by the appended claims, and are contemplated to cover any and all modifications, variations, combinations, or equivalents that fall within the scope of the disclosure.

What is claimed is:

1. A method for querying and updating entries in a database, comprising a main data structure configured to store database entries and a delta data structure configured to store and receive new entries, the method comprising:
receiving a plurality of database queries;
aggregating the received plurality of database queries to obtain a batch of database queries;
performing a shared scan of the main data structure with the batch of database queries, wherein the database entries in the main data structure are queried with respect to each database query in the batch of database queries; and
merging the main data structure with the delta data structure to update the main data structure with the new entries after performing the shared scan of the main data structure with the batch of database queries.

2. The method of claim 1, further comprising receiving a second plurality of database queries, wherein after merging the main data structure with the delta data structure to update the main data structure, the method further comprises:
aggregating the received second plurality of database queries to obtain a second batch of database queries;
performing a second shared scan of the main data structure with the second batch of database queries, wherein the database entries in the main data structure are queried with respect to each query in the second batch of database queries; and
merging the main data structure with the delta data structure to update the main data structure with new entries after performing the second shared scan.

3. The method of claim 1, wherein performing the shared scan and merging the main data structure with the delta data structure are performed at different instants of time.

4. The method of claim 1, wherein performing the shared scan and merging the main data structure with the delta data structure are performed at predetermined instants of time.

5. The method of claim 1, further comprising establishing queues for different classes of database queries, wherein the database queries are at least one of point queries and analytic queries.

6. The method of claim 5, further comprising scheduling classes of database queries in the batch of database queries in dependence of a response time requirement for each class of database queries.

7. The method of claim 1, further comprising:
receiving a plurality of new entries;
aggregating a received plurality of new entries to obtain a batch of new entries; and
updating the delta data structure with the batch of new entries in an update step.

8. The method of claim 1, wherein at least one of the shared scan and the merging of the main data structure with the delta data structure is performed using indices.

9. The method of claim 1, wherein at least one of the shared scan and the merging of the main data structure with the delta data structure is performed using a hash table.

10. The method of claim 1, wherein updating the delta data structure with new entries is performed using indices.

11. The method of claim 1, wherein updating the delta data structure with new entries is performed using a hash table.

12. The method of claim 1, comprising:
receiving a database query;
determining a class of the received database query; and
including the database query into the batch of database queries depending on the determined class.

13. The method of claim 1, comprising:
receiving a database query;
determining a class of the received database query; and
directly querying the main data structure with the received database query upon the basis of a hash table.

14. The method of claim 13, comprising executing the batch of database queries and directly querying the main data structure in an interleaved manner or in a shared manner.

15. The method of claim 1, further comprising performing a snapshot isolation of the batch of database queries.

16. The method of claim 1, further comprising receiving new entries for updating the delta data structure.

17. A non-transitory computer-readable medium having computer executable instructions stored thereon for execution by a processor, wherein the instructions cause the processor to:
receive a plurality of database queries;
aggregate the received plurality of database queries to obtain a batch of database queries;
perform a shared scan of the main data structure with the batch of database queries, wherein the database entries in the main data structure are queried with respect to each database query in the batch of database queries; and
merge the main data structure with the delta data structure to update the main data structure with the new entries after performing the shared scan of the main data structure with the batch of database queries.

18. A data processing system, comprising:
a database comprising:
a main data structure configured to store database entries; and
a delta data structure configured to store and receive new entries;
a communication interface for receiving a plurality of database queries and for receiving new entries; and
a processor coupled to the database and the communication interface, wherein the processor is configured to:
aggregate the received plurality of database queries to obtain a batch of database queries;
perform a shared scan of the main data structure with the batch of database queries, wherein the database entries in the main data structure are queried with respect to each database query in the batch of database queries; and
merge the main data structure with the delta data structure to update the main data structure with the new entries after performing the shared scan of the main data structure with the batch of database queries.

19. The data processing system of claim 14, wherein the processor is configured to perform the shared scan and merge the main data structure with the delta data structure at different instants of time or at predetermined instants of time.
